(19) United States
(12) Patent Application Publication
(10) Pub. No.: US 2007/0039788 A1
(43) Pub. Date: Feb. 22, 2007

(54) Magnetic braking system for a cable supported vehicle

(76) Inventor: Robert H. Fulton, North Delta (CA)

Correspondence Address: KOLISCH HARTWELL, P.C., 200 PACIFIC BUILDING, 520 SW YAMHILL STREET, PORTLAND, OR, 97204, US

(21) Appl. No.: 11/209,482

(22) Filed: Aug. 22, 2005

(51) Int. Cl. B60L 7/00

(52) U.S. Cl. 188/164

(57) ABSTRACT

A braking system for a movable unit which travels along a cable includes a plate of conductive material extending from the cable to define a braking zone having a start and an end along at least a portion of the cable. There is a brake unit movable along the cable and positionable at the start of the braking zone. The brake unit has magnets positionable on opposite sides of the conductive material. The brake unit is engagable by the movable unit when the movable unit reaches the start of the braking zone to couple the two units together. The movable unit acts to push the brake unit through the braking zone such that movement of the magnets of the brake unit relative to the conductive material induces eddy currents in the conductive material to create a braking force between the brake unit and the plate of conductive material to brake the brake unit and the movable unit. In an alternative arrangement, the magnets are installed directly in the movable unit to eliminate the separate brake unit. The braking system provides for reliable, low ‘g’ force, high energy absorption operation in all weather conditions with minimal maintenance.

### FIELD OF THE INVENTION

This invention relates to a braking system for a vehicle travelling on a cable, and more particularly, to a braking system for a recreational cable line ride.

### BACKGROUND OF THE INVENTION

Recreational cable line rides are becoming popular in high profile resort areas such as Whistler, British Columbia, Canada. Cable line rides generally involve riders traveling on a carriage or trolley that moves along a cable run suspended between two end points. Often, the cable run extends between two sides of a valley, and the carriage and rider move from a first, higher end point to a second, lower end by gravity. When the carriage and rider reach the lower end of the cable run, it is necessary to brake and stop the carriage so that the rider can safely disembark from the ride.

Current braking systems for cable line rides tend to rely on friction braking or a buffer system incorporating energy absorbing springs to slow and stop the carriage. Such systems are prone to wear and require rigorous maintenance to ensure safe and reliable operation. Their effectiveness also tends to be adversely affected by weather conditions. Operation in wet or icy conditions renders friction brakes significantly less effective.

Linear magnetic brake technology is well developed and is currently applied to roller coaster, trolley on fixed tracks, and larger water slide rides to provide deceleration from high speeds. These braking systems are substantially maintenance free. There are no moving parts, and no electrical source required to run the system since the technology relies on permanent magnets and aluminum conductors with no wearing surfaces.

Linear magnetic brake technology works according to the principle that moving a metal plate such as an aluminum or copper conductor plate in the air gap of a magnet induces current in the metal plate. The current will flow back through the zero-field areas of the metal plate and thus create a closed current eddy loop. A flow of current always means there is a magnetic field as well. Due to Lenz's law, the magnetic field created by the eddy current reacts against the direction of movement. Instead of mechanical friction, ‘magnetic friction’ is created.

This technology is also referred to as linear eddy-current brakes in reference to the eddy currents set up in a conductor plate. Linear eddy-current brakes are always the best choice when demands for reliability and safety are highest. These brakes provide a smooth braking action as the braking force builds up continuously when the conductor plate moves relative to the permanent magnets. Braking with permanent magnets works independently of any other system and is free of wear and tear even in severe weather conditions, including lightening strikes, ice, snow, rain and high wind. Typically, these brakes are also corrosion and UV resistant. Governing authorities readily accept magnetic brakes as “fail safe” since the technology has been thoroughly tested and certified in the specific applications in which it has been used commercially to date.

To date, the technology involved in linear magnetic brakes has not been applied to the braking environment of a cable line system. This represents a major challenge. Current linear magnetic braking applications are typically built into a solid structural framework over which a heavy car on a track carries a conductor plate or fin through the magnets arranged in several sections in a deceleration zone. Alignment of the conductor plates and the magnets is ensured. In the case of suspended cables, any linear magnetic braking system has to accommodate movements in the cable, the slope of the cable and movements due to temperature fluctuations both in the cable and in the conductor plates. This represents a significant problem in ensuring consistent alignment between the permanent magnet associated with one of the carriage to be braked and the cable, and the conductor plate associated with the other of the carriage and the cable to ensure that the magnet and the conductor plate are able to move past each other to generate the desired magnetic braking force.

### SUMMARY OF THE INVENTION

The braking system of the present invention has been developed to address the foregoing problems and to adapt the linear magnetic braking system to the new environment of a cable system.

The present invention provides a reliable, ‘fail safe’ linear magnetic braking system that is adapted for use with a suspended cable system. The present invention provides a smooth, low ‘g’ braking effect in all weather conditions with minimal maintenance.

Accordingly, the present invention provides a braking system for a movable unit which travels along a cable comprising:

a plate of conductive material extending from the cable to define a braking zone having a start and an end along at least a portion of the cable;

a brake unit movable along the cable and positionable at the start of the braking zone, the brake unit having magnets positionable on opposite sides of the conductive material, and the brake unit being engagable by the movable unit when the movable unit reaches the start of the braking zone;

whereby the movable unit acts to push the brake unit through the braking zone such that movement of the magnets of the brake unit relative to the conductive material induces eddy currents in the conductive material to create a braking force between the brake unit and the plate of conductive material to brake the brake unit and the movable unit.

In a further aspect, the present invention provides a method for braking a movable unit which travels along a cable comprising:

providing a plate of conductive material extending from the cable to define a braking zone having a start and an end along at least a portion of the cable;

positioning a brake unit movable along the cable at the start of the braking zone, the brake unit having magnets positionable on opposite sides of the conductive material;

engaging the brake unit with the movable unit when the movable unit reaches the start of the braking zone to cause the movable unit to push the brake unit through the braking zone whereupon movement of the magnets of the brake unit relative to the conductive material induces eddy currents in the conductive material to create a braking force between the brake unit and the plate of conductive material to brake the brake unit and the movable unit.

The present invention relies on a conductor plate mounted underneath the cable to define a braking zone. The conductor plate is formed from a plurality of interconnected segments to accommodate the curvature of the cable. An incoming carriage or trolley carrying a rider contacts and engages a travelling brake unit housing permanent magnets that is positioned at the start of the braking zone. Both the carriage and the brake unit then travel through the braking zone where magnetic braking occurs.

During magnetic braking, the kinetic energy of the moving carriage coupled with the moving brake unit is converted into thermal energy which is rapidly dissipated from the conductor plate. The carriage and brake unit decelerate while the conductor plate heats up due to induced eddy currents. The braking force is dependent on the entry velocity of the carriage into the braking zone and the material of the conductor plate (i.e. the plate's specific resistance). Braking force will build up with speed until deceleration reaches a maximum and will then drop off, leaving a residual velocity after the braking zone. A secondary buffer zone at the end of the cable may be provided to bring the carriage to a complete stop The secondary buffer zone may be composed of an array of elastomer damping units in series and co-axial with the cable.

The braking zone may be as long as 20 metres for higher velocity rides (15-18 m/s) and as short as 10 metres for slower rides (8-10 m/s). At the end of the braking zone the velocity of the carriage will be slowed down to 3 m/s. The frequency of incoming carriages is such that the conductor plate would have sufficient time to cool from induced heat.

### BRIEF DESCRIPTION OF THE DRAWINGS

Aspects of the present invention are illustrated, merely by way of example, in the accompanying drawings in which:

FIG. 1 is an elevation view of a cable line system incorporating a preferred embodiment of the linear magnetic braking system of the present invention;

FIG. 1a is a detail view of the braking zone of cable system of FIG. 1;

FIG. 2 is a detail side elevation view of a preferred embodiment of a movable unit or carriage supporting a rider;

FIG. 2a is a front view of the carriage and rider;

FIG. 3 is a detailed perspective view of the carriage and brake unit according to a preferred embodiment of the invention;

FIG. 3a is a detail side view of the conductive plates that define the braking zone showing the manner in which they are attached to the cable;

FIG. 3b is a section view through the cable and conductor plate taken along line 3b-3b of FIG. 3a;

FIGS. 4, 4a and 4b are side elevation, end and plan views, respectively, of a preferred carriage;

FIGS. 5, 5a and 5b are side elevation, end and plan views, respectively, of a preferred brake unit;

FIGS. 6 and 7 are detail perspective view showing the sequence of events as the carriage engages and couples with the brake unit by operating of the coupling device;

FIGS. 8 and 8a are views of a preferred secondary buffer system with a recoil control damper for bringing the carriage and brake unit to a full stop; and

FIGS. 9 and 9a are views of an alternative embodiment of the present invention in which the carriage and brake unit are combined into a single unit.

### DESCRIPTION OF THE PREFERRED EMBODIMENTS

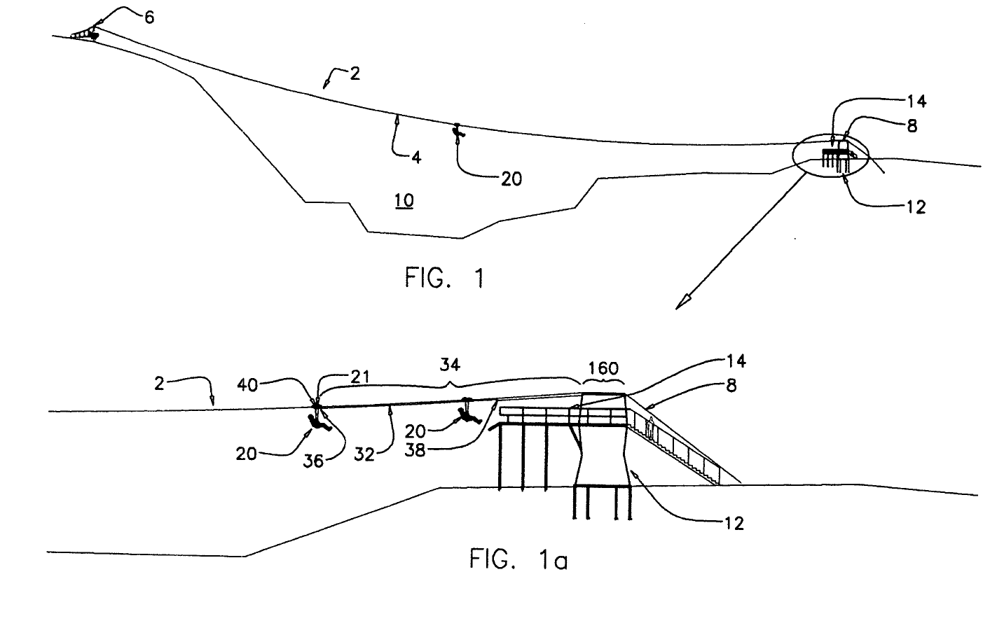

Referring to FIGS. 1 and 1a, there is shown an exemplary cable line ride system 2 incorporating a preferred embodiment of the magnetic braking system of the present invention. Cable line ride 2 comprises a cable 4 suspended between a first, higher end point 6 and a second, lower end point 8 on opposite sides of a valley 10. In the illustrated embodiment, first, upper end point 6 is created using applicant's SYSTEM FOR SUSPENDING STRUCTURES FROM TREES as described in co-pending U.S. patent application No. 10/859,699 filed on Jun. 4, 2004, the disclosure of which is incorporated herein by reference. First upped end point 6 defines a launch platform for the cable line ride. Second lower end point 8 includes a raised structure 12 defining a landing platform 14. It will be appreciated that alternative structures for anchoring the ends cable 2 are possible in order to suspend the cable in place.

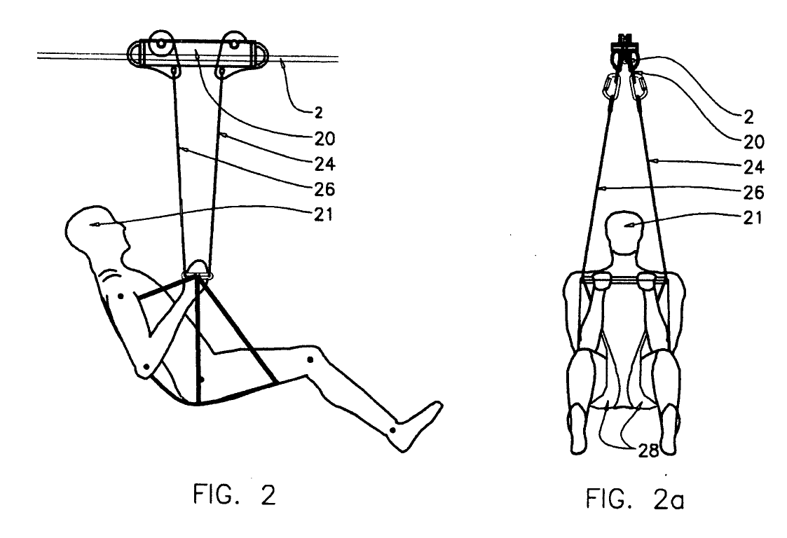

Movable units in the form of carriages 20 support riders 21 for travel along cable 2 from upper end point 6 to lower endpoint 8 by gravity. FIGS. 2 and 2a show a preferred embodiment of carriage 20 mounted on cable 2. Rider 21 is suspended below carriage 20 and cable 2 by a harness system 24. In the illustrated embodiment, harness system 24 supports the rider in substantially a sitting position. Support cables 26 extend downwardly from carriage 20 to define a support structure formed from straps 28 and a spreader bar 30 for gripping by the rider. Alternative arrangements for supporting the rider below cable 2 are possible and will be readily apparent to a person skilled in the art. Carriage 20 illustrated and described in more detail below is only one example of a movable unit suitable for travel along cable 20 that will work with the braking system of the present invention.

When carriage 20 and rider 21 reach the lower end of cable 2, it is necessary to brake and slow the carriage so that the rider can safely disembark from the ride at landing platform 14. This is achieved using the braking system 30 of the present invention. FIG. 1a provides a more detailed view of the lower end 8 of cable 2 including braking system 30 for slowing carriages 20 travelling along cable 2. Preferably, lower end point 8 of cable 2 includes an upwardly sloping section to assist in slowing of the carriage, but this is not necessary with the present braking system.

Braking system 30 includes a plate 32 of conductive material extending from cable 2 to define a braking zone 34 at the lower end of the cable having a start 36 and an end 38. The plate of conductive material defining the braking zone may be as long as 20 metres for higher velocity rides (15-18 m/s) and as short as 10 metres for slower rides (8-10 m/s). Preferably, plate 32 of conductive material is formed from aluminum which has good cooling characteristics and is flexible to accommodate movement of the cable, however, it is understood that other conductive material may be used.

A brake unit 40 movable along the cable, and positionable at start 36 of the braking zone is also provided. As will be discussed in more detail below, brake unit 40 includes magnets positionable on opposite sides of plate 32. The brake unit is engagable by a carriage 20 as the carriage descends along cable 2 and reaches start 36 of braking zone 34. Carriage 20 acts to push brake unit 40 through the braking zone 34 such that movement of the magnets of the brake unit relative to the stationary conductive material of plate 32 induces eddy currents in the conductive material with the result that a braking force acting on brake unit 40 is created. As brake unit 40 slows down due to braking, following carriage 20 is also slowed down.

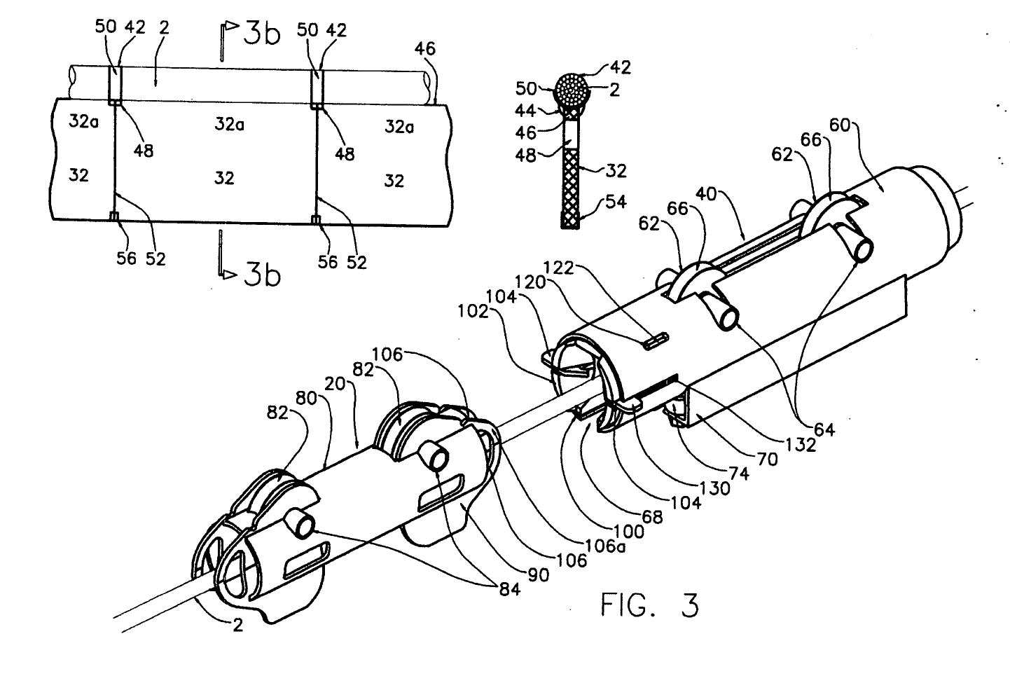

FIGS. 3 to 3b provide detail views of preferred embodiments of the conductive plate 32, carriage 20, and brake unit 40 of the braking system.

Turning first to FIGS. 3a and 3b, conductive plate 32 is preferably formed from a continuous plate mounted to the cable at a plurality of spaced, connection points 42 along the length of the braking zone to accommodate flexing of the cable. The continuous plate 32 includes a channel member 44 along an upper edge 46 to receive cable 2. Each of the plurality of connection points 42 comprises an opening 48 through plate 32 adjacent channel member 44, and a band 50 looped over the cable, under the channel member and through the opening to connect plate 32 to the cable as best shown in section view 3b. Plate 32 is formed with a slit 52 extending from a lower edge 54 upwardly to each opening 48 of the plurality of connection points 42 to define interconnected plate segments 32a joined along upper edge 46 of the continuous plate. Plate segments 32a are free to separate from each other along each slit 52 to permit flexing of the continuous plate with the cable. Preferably, three is a clip 56 overlapping each slit 52 at lower edge 54 of the continuous plate to maintain alignment of the interconnected plate segments in the plane of the cable.

FIG. 3 shows carriage 20 and brake unit 40 on cable 2 just prior to carriage 20 engaging brake unit 40 at the start of the braking zone. For clarity of the drawings, note that FIG. 3 does not show conductive plate 32 attached to cable 2.

Brake unit 40 comprises a generally cylindrical body 60 which rotatably supports at least one roller 62. In the illustrated embodiment, a pair of spaced rollers 62 are shown. Each roller is a conventional unit with an internal hub fitted onto axle 64 extending transversely to the body of the brake unit. The tread surface 66 of each roller 62 is preferably formed from a hard elastomer such as urethane of 90 durometer hardness, however, it will be understood that other suitable materials of different hardness can be used. Tread surface 66 is concave and dimensioned to receive and run along the upper surface of cable 2 in order to movably support body 60 on the cable.

FIGS. 5-5b provide additional views of brake unit 40. As best shown in FIG. 5a, which is an end view of the brake unit, cylindrical body 60 includes a downwardly opening central channel 68 aligned with rollers 62 to permit body 60 to straddle the cable and attached conductive plate 32. Cylindrical body 60 also includes a lower magnet housing 70 for mounting of permanent magnets 72 on opposite sides of central channel 68 to position the magnets on opposite sides of plate 32. Preferably, the magnets are rare earth magnets which offer good magnetic strength for their size and are resistant to demagnetization.

Within central channel 68, pairs of alignment rollers 74 extend inwardly from opposite sides to engage plate 32.. Alignment rollers 74 maintain the central channel 68 substantially centred about cable 2 and plate 32.

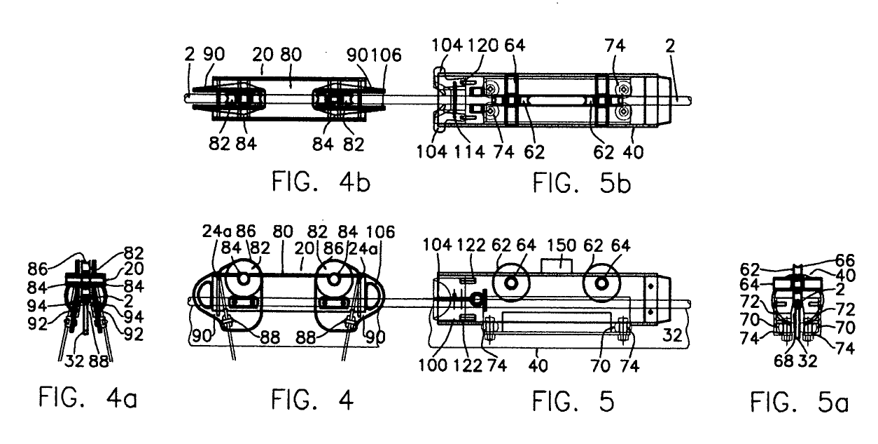

Referring to FIGS. 3, 4, 4a and 4b, carriage 20 is also preferably formed as a generally cylindrical body 80 rotatably supporting at least one roller 82. In the illustrated embodiment, a pair of spaced rollers 82 are employed. Each roller 82 is a conventional unit with an internal hub fitted onto axle 84 extending transversely to the body of the carriage and with a concave tread surface 86 of hard urethane to movably support body 80 on the cable. As best shown in the end view of FIG. 4a, cylindrical body 80 is formed with a downwardly opening central channel 88 aligned with rollers 82 to permit body 80 to straddle and travel along cable 2. As best shown in FIG. 4, lines 24a of harness system 24 for supporting a rider are preferably looped over and through cylindrical body 80 to extend downwardly on opposite sides to anchor the harness system to the body of carriage 20. At each end of body 80, pairs of flared housing plates 90 extend downwardly and diverge. Plates 90 provide mounting points for cable clamps 88 to secure lines 24a, and act to keep the lines away from cable 2. Cable guide blocks 92 are mounted to the internal surface of plates 90 and act to centre body 80 on cable 2. Access windows 94 are formed through cylindrical body 80 to permit adjustment of guide blocks 92.

When carriage 20 approaches the braking zone after descending along cable 2 and initially contacts brake unit 40 to begin the braking process, it is preferable that the carriage and the brake unit are releasably coupled together to prevent carriage 20 from repeatedly striking and rebounding from brake unit 40 as they travel through the braking zone. To achieve this, brake unit 40 preferably includes a coupling device 100 to permit releasable coupling of carriage 20 to the brake unit on initial contact between the two.

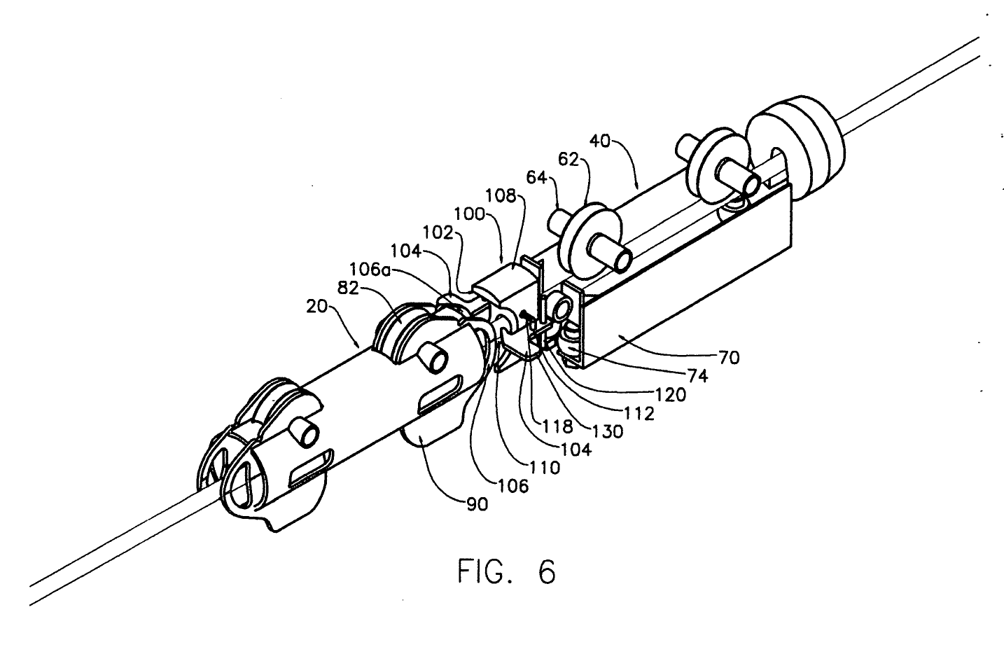

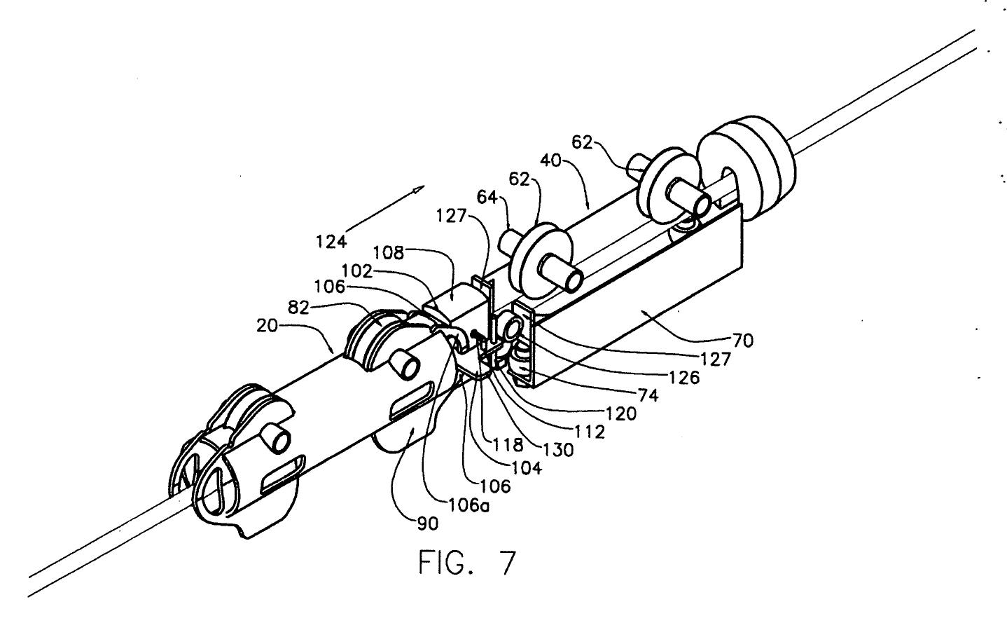

FIGS. 3, 6 and 7 show various aspects of a preferred coupling device 100 and its operation. In FIGS. 6 and 7, portions of the cylindrical body of the brake unit 40 have been removed for clarity.

Initially, FIG. 3 shows carriage 20 approaching brake unit 40 at the start of the braking zone. Coupling device 100 is positioned at the end of brake unit 40 facing carriage 20. The coupling device comprises a docking cavity 102 to receive an end of carriage 20, and at least one coupling hook 104 to engage and hold the end of the carriage within the docking cavity. At the same time, carriage 20 is formed with at least one end having at least one latching site for coupling hook 104. In the illustrated embodiment, there are a pair of coupling hooks 104 to engage a pair of latching sites 106 which include openings 106a through flared housing plates 90.

FIG. 6 shows carriage 20 just as it makes contact with brake unit 40. The cylindrical outer body of the brake unit is not show to provide an unobstructed view of docking cavity 102 and coupling hooks 104. Docking cavity 102 is a depression shaped to receive the protruding end of carriage 20. Cavity 102 is formed in a movable block 108 which is slidably mounted within the body of the brake unit. Block 108 is shown partially sectioned in FIG. 6 and includes a lower slot 110 to accommodate cable 2. On opposite sides of block 108, coupling hooks 104 are positioned for movement between a default engaged position to hold and retain the end of carriage 20, and a released position to permit disengagement of the hooks from latching sites 106. Spring 112 extending between anchor posts 114 on each hook and through passage 118 in block 108 to bias the hooks toward each other and into the default latched position. Hooks 104 pivot about elongate pins 120. Pins 120 are slidably retained at their upper and lower ends in slots 122 formed in the cylindrical body of the brake unit to guide movement of block 108 (see FIG. 3). As carriage 20 initially contacts brake unit 40, latching sites 106 on plates 90 force hooks 104 apart to the released position against the biasing force of spring 118 to allow the end of carriage 20 to move into docking cavity 102. FIG. 7 shows latching sites 106 fully engaged in docking cavity 102. After latching sites 106 are fully engaged in the docking cavity, spring 118 is able to bias hooks 104 back into the default latched position such that the hooks 104 are engaged in latching sites openings 106a to couple the carriage and brake unit together. Block 108 is adapted to absorb the initial impact of the engagement of the latching sites 106 with docking cavity 102 by moving in the direction indicated by arrow 124 in FIG. 7. This slidable movement is guided and accommodated by pins 120 moving in slots 122 in the outer cylindrical body. At the end of the travel of block 108, impact absorbing elements 126 associated with the brake unit act to further absorb the impact of the carriage engaging with the brake unit. Preferably, impact absorbing elements 126 comprise at least one deformable ring member which resiliently deforms when contacted by block 108 as the block slides in the direction of arrow 124. Elements 126 are mounted to an internal wall 127 of brake unit 40. Spring 118 extending through block 108 between posts 112 tends to bias block 108 forwardly in the opposite direction to arrow 124 to ensure that block 108 and docking cavity 102 are properly positioned to receive the end of a carriage 20. Note that the coupling device 100 is arranged such that latching hooks 104 are engaged with latching openings 106a prior to block 108 sliding into contact with impact absorbing elements 126 to ensure that the hooks hold and retain the end of the carriage during any impact of block 108 with elements 126.

Latching hooks 104 are formed with tabs 130 that protrude through slots 132 formed in the cylindrical body of brake unit 40 as best shown in FIG. 3. Tabs 130 are manipulated by a rider or operator to pivot hooks 104 out of latching site openings 106a to permit disengagement of carriage 20 from brake unit 40 after the brake unit has performed its braking function. The brake unit 40 is then returned to its starting position at the start 36 of braking zone 34 (FIG. 1a) to engage and stop the next carriage 20 and rider 21 travelling down cable 2. Movement of brake unit 40 to the start 36 of braking zone 34 can be accomplished in several ways. For example, as shown in FIG. 5, brake unit 40 can be equipped with a motor 150 to drive rollers 62 along cable 2 to the start of the braking zone. Motor 150 is preferably battery powered and under radio control to allow an operator to readily control the position of the brake unit. Alternatively, a close line type system for manually moving brake unit 40 to the beginning of the braking zone can be used. If the braking zone is readily accessible to the operator based on the geometry of the cable at the braking zone, it may simply be a matter of the operator moving the brake unit manually pushing it to the start of the braking zone.

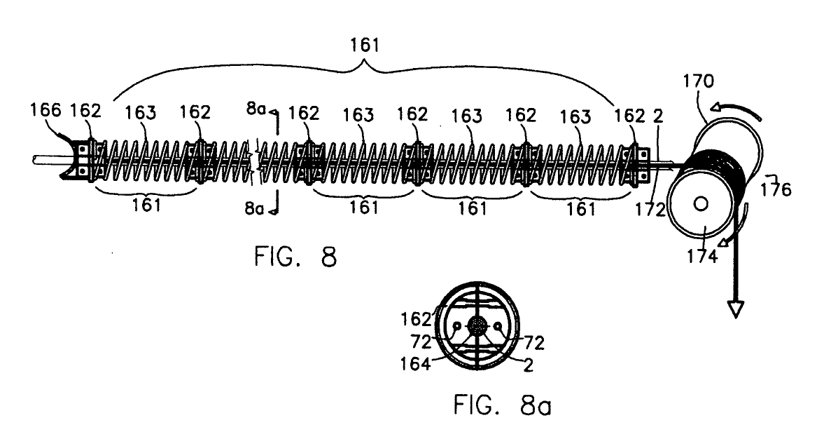

The nature of the braking forces generated in the linear magnetic braking system of the present invention mean that the carriage and rider are not brought to a complete stop at the end of braking zone 34. The braking system does substantially reduce the speed of the carriage along the cable, for example, from a speed of 18 m/s at the beginning of the braking zone to a speed of 3 m/s at the end of the zone. Depending on the configuration and dimensions of the cable and landing platform 14, this lower speed may permit a rider to slow themselves to a complete stop by standing up in the harness and putting their feet on the landing platform (see FIG. 1). To further assist in stopping carriage 20 and the rider 21, a buffer section 160 may be installed on cable 2 after braking zone 34. Preferably, buffer section 160 comprises an array of elastomer damping units in series and co-axial with the cable adapted to absorb and cushion movement of the brake unit and carriage and bring them to a complete stop. FIGS. 8 and 8a show buffer section 160 in detail. Elastomer damping units 161 comprises a pair of generally disc shaped bodies 162 having a central hole 164 to permit passage of cable 2 through the bodies. An associated axially aligned spring 163 extends between the pair of disc bodies 162 which are formed with an annular flange to receive and retain the ends of the spring. Damping units 161 are strung together end to end in series to define buffer section 160. Typically, up to 15 damping units would be positioned on a cable to define a buffer section. Each disc body 162 is preferably formed from an ultrahigh molecular weight (UHMW) plastic and serves to align and centre the springs over cable 2. When a carriage and brake unit impact the exposed end 166 of the buffer section, springs 163 are compressed and this deformation of the springs absorbs the momentum of the carriage and brake unit. To avoid the springs recoiling and sending the carriage and brake unit back along the cable, a recoil control device can also be incorporated into buffer section 160. In a preferred arrangement, recoil control device 170 comprises a pair of control cables 172 extending through each disc body 162 parallel to and on opposite sides of cable 2 as best shown in FIG. 8a, which is a section view through the buffer section taken along line 8a-8a of FIG. 8. Control cables 172 are wound onto the drum 174 of a hydraulic damper unit 176 with a sprague clutch. The drum 174 of hydraulic damper unit 176 operates to take up slack in the control cables on compression of the springs to prevent recoil of the springs. Control cables 172 may be connected to counter-weights to maintain the control cables taut.

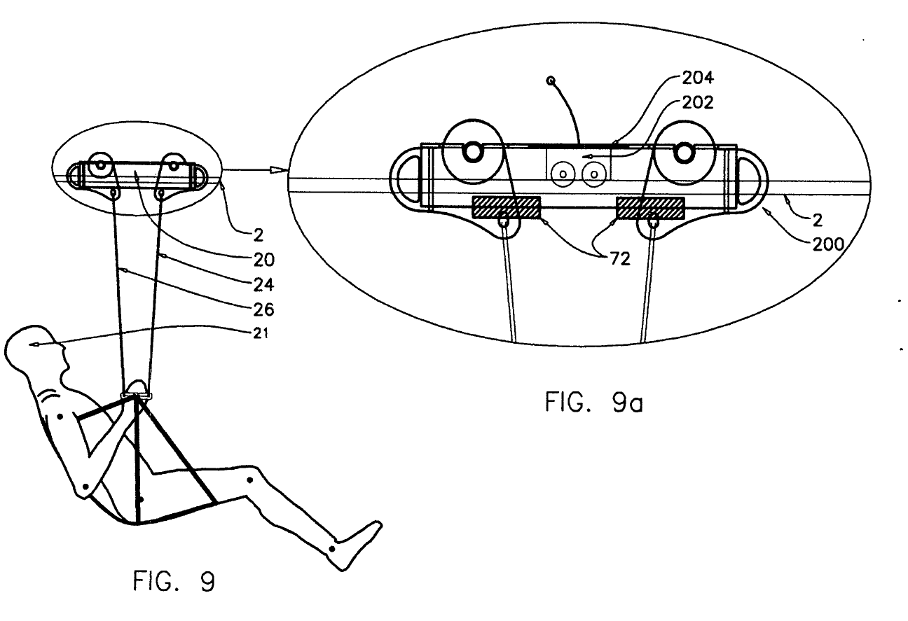

FIGS. 9 and 9a shows a further embodiment of the present invention in which the carriage 20 and brake unit 40 are combined into a single unit 200. In this alternative arrangement, a plate of conductive material 32 suspended below cable 2 still defines the braking zone 34, however, there is no longer a separate braking unit 40. Instead, as best shown in FIG. 9a, carriage 200 is fitted with permanent magnets 72 for positioning on opposite sides of the plate of conductive material 32 when the carriage reaches the start of the braking zone. As in the previous embodiment, movement of the magnets of the carriage relative to the conductive material induces eddy currents in the conductive material to create a braking force between the carriage and the plate of conductive material to brake the movable unit.

This arrangement eliminates the need to circulate carriages from the end of the ride to the beginning for the next rider as each cable has it's own captive carriage running back and forth on the cable. Referring to FIG. 9a, the return of carriage 200 along cable 2 to the start of the run is preferably performed by a DC electric drive 202 incorporating a gear box and clutch powered by a solar charged battery system. The battery system is charged through solar panel 204. The drive 202 only operates to move the carriage uphill along the cable. As in the previous embodiment, movement of the carriage down the cable is by gravity. In other words, carriage 200 moves down the cable carrying a rider under gravity and returns up the cable empty using drive 202. A radio control unit may be incorporated in drive 202 to allow the operator to move carriage 200 under remote control back to the start of the cable.

The alternative arrangement shown in FIGS. 9 and 9a will tend to yield higher speed rides because the carriage is heavier with its additional magnet and drive components. Such a carriage would be advantageous for lighter riders. Another advantage of this alternative system is that it eliminates the impact of the carriage on the brake unit. This system is less expensive overall because there will tend to be fewer carriages in the system, and a separate brake unit is not required.

Although the present invention has been described in some detail by way of example for purposes of clarity and understanding, it will be apparent that certain changes and modifications may be practised within the scope of the appended claims.

I claim:

1. A braking system for a movable unit which travels along a cable comprising:
a plate of conductive material extending from the cable to define a braking zone having a start and an end along at least a portion of the cable;
a brake unit movable along the cable and positionable at the start of the braking zone, the brake unit having magnets positionable on opposite sides of the conductive material, and the brake unit being engagable by the movable unit when the movable unit reaches the start of the braking zone;
whereby the movable unit acts to push the brake unit through the braking zone such that movement of the magnets of the brake unit relative to the conductive material induces eddy currents in the conductive material to create a braking force between the brake unit and the plate of conductive material to brake the brake unit and the movable unit.

2. The braking system of claim 1 including a buffer section after the braking zone.

3. The braking system of claim 2 in which the buffer section includes an array of elastomer damping units in series and co-axial with the cable.

4. The braking system of claim 1 in which the plate of conductive material is formed from a plurality of aligned, interconnected plates suspended from the cable to define a substantially continuous surface of conductive material that will accommodate flexing of the cable.

5. The braking system of claim 4 in which the continuous plate includes a channel member along an upper edge to receive the cable, and each of the plurality of connection points comprises an opening through the plate adjacent the channel member and a band looped over the cable, under the channel member and through the opening to connect the plate to the cable, the plate being formed with a slit extending from a lower edge upwardly to each opening of the plurality of connection points to define interconnected plate segments joined along the upper edge of the continuous plate but free to separate along each slit to permit flexing of the continuous plate with the cable.

6. The braking system of claim 5 including a clip overlapping each slit at the lower edge of the continuous plate to maintain alignment of the interconnected plate segments in the plane of the cable.

7. The braking system of claim 1 in which the conductive material comprises aluminium.

8. The braking system of claim 1 in which the brake unit comprises:
a body;
at least one roller rotatably mounted to the body for engagement with the cable to movably support the body on the cable; and
a housing within the body defining a central channel through the body with the magnets being mounted on opposite sides of the channel to position the magnets on opposite sides of the plate of conductive material.

9. The braking system of claim 8 in which the brake unit includes a coupling device to permit releasable coupling of the movable unit to the brake unit when the movable unit engages the brake unit.

10. The braking system of claim 9 in which the coupling device comprises:
a docking cavity to receive an end of the movable unit; and
at least one coupling hook to engage and hold the end of the movable unit within the docking cavity of the brake unit.

11. The braking system of claim 10 in which the docking cavity is a depression formed in a movable block slidably mounted in the body of the brake unit.

12. The braking system of claim 10 in which the at least one coupling hook comprises a pair of coupling hooks on opposite sides of the cable movable between a default engaged position to hold and retain the end of the movable unit, and a released position to permit disengagement of the end of the movable unit from the docking cavity.

13. The braking system of claim 8 in which the brake unit includes alignment rollers to maintain the central channel substantially centred about the cable and the plate of conductive material.

14. The braking system of claim 8 including an impact absorbing element associated with the brake unit to cushion the impact of the movable unit engaging with the brake unit.

15. The braking system of claim 14 in which the impact absorbing element comprises at least one deformable ring member.

16. The braking system of claim 1 in which the movable unit comprises:
a body;
at least one roller rotatably mounted to the body for engagement with the cable to movably support the body on the cable; and
a harness system suspended from the body to support a rider.

17. The braking system of claim 16 in which the body includes a central channel to receive the cable with housings extending from the body to define ends of the movable unit for engaging and coupling with the brake unit.

18. The braking system of claim 1 in which the magnets of the brake unit are permanent magnets.

19. The braking system of claim 18 in which the permanent magnets are rare earth magnets.

20. The braking system of claim 2 in which the buffer section includes a recoil damping device.

21. A method for braking a movable unit which travels along a cable comprising:
providing a plate of conductive material extending from the cable to define a braking zone having a start and an end along at least a portion of the cable;
positioning a brake unit movable along the cable at the start of the braking zone, the brake unit having magnets positionable on opposite sides of the conductive material;
engaging the brake unit with the movable unit when the movable unit reaches the start of the braking zone to cause the movable unit to push the brake unit through the braking zone whereupon movement of the magnets of the brake unit relative to the conductive material induces eddy currents in the conductive material to create a braking force between the brake unit and the plate of conductive material to brake the brake unit and the movable unit.

22. A braking system for a movable unit which travels along a cable comprising:
a plate of conductive material extending from the cable to define a braking zone having a start and an end along at least a portion of the cable;
magnets associated with the movable unit for positioning on opposite sides of the conductive material when the movable unit reaches the start of the braking zone;
whereby movement of the magnets of the movable unit relative to the conductive material induces eddy currents in the conductive material to create a braking force between the movable unit and the plate of conductive material to brake the movable unit.
